(19) United States
(12) Patent Application Publication
(10) Pub. No.: US 2024/0025777 A1
(43) Pub. Date: Jan. 25, 2024

(54) SYSTEM AND METHOD FOR REDOX POLYMER ELECTRODIALYSIS

(71) Applicant: The Board of Trustees of the University of Illinois, Urbana, IL (US)

(72) Inventors: Xiao SU, Champaign, IL (US); Nayeong Kim, Champaign, IL (US); Johannes Elbert, Urbana, IL (US)

(21) Appl. No.: 18/223,653

(22) Filed: Jul. 19, 2023

Related U.S. Application Data
(60) Provisional application No. 63/391,467, filed on Jul. 22, 2022.

(51) Int. Cl. C02F 1/469; B01D 61/46; B01D 61/02; B01D 71/10; B01D 69/02; C02F 1/44

(52) U.S. Cl. CPC C02F 1/4693; B01D 61/46; B01D 61/027; B01D 71/10; B01D 69/02; C02F 1/442; B01D 2325/02831; B01D 2325/02832; C02F 2305/00; C02F 2103/08

(57) ABSTRACT

A system for redox polymer electrodialysis includes: a first electrode; a second electrode positioned in opposition to the first electrode; a pair of size-exclusion membranes positioned between the first and second electrodes; an ion exchange membrane positioned between the pair of size-exclusion membranes, the ion exchange membrane defining a feed channel and an accumulating channel between the size-exclusion membranes; and a redox channel containing the first and second electrodes and being separated from the feed and/or accumulating channels by the pair of size-exclusion membranes.

### RELATED APPLICATION

The present patent document claims the benefit of priority to U.S. Provisional Patent Application No. 63/391,467, which was filed on Jul. 22, 2022, and is hereby incorporated by reference in its entirety.

### TECHNICAL FIELD

The present disclosure is generally related to a system and method for purifying water from various sources, and more specifically to redox polymer electrodialysis.

### BACKGROUND

Water scarcity and contamination are a critical global concern, with over 67% of the world population experiencing severe water scarcity at least part of the year. Pressure on clean water supply has been increasing worldwide due to prevalent organic contaminants arising from industrial waste, anthropogenic activities, and agricultural practices. Although water treatment technologies have made significant strides to alleviate the growing pressure on water supply, desalination processes are often energy intensive processes, attributing to ˜50% of the water production cost. Besides, the presence of a variety of contaminants (e.g., organic matter, charged organics, and oil residues) burden the water treatment processes due to the propensity for fouling/scaling or aging of the desalination equipment. Thus, developing robust technologies and materials that can withstand fouling and be operated with lower energy become a central challenge for desalination.

Electrochemical separation methods, including capacitive deionization, redox-mediated electrosorption (e.g., intercalation and redox polymer), and electrodialysis have received growing attention as promising candidates for water treatment and environmental remediation due to sustainable and energy-efficient operation, as well as modularity and potential integration with renewable energy in remote locations.

For electrodialysis technologies, the ion-exchange membrane (IEM) can be a critical component as it provides the charge-separation barrier for desalination. However, IEMs may also be one of the greatest bottlenecks for widespread utilization of electrodialysis, due to high membrane costs and propensity for fouling. In particular, anion exchange membranes (AEMs) may be fouled by a wide range of negatively charged organic and bio-substances such as surfactants, carboxylates, bacteria, and proteins. Carboxylic acids such as humic acid and octanoic acid are the most common foulants of AEMs because of their ubiquitous presence in both natural water and wastewater, and exacerbated by the excessive use of detergents, pesticides, and plastics. When these organic and bio-molecules are adsorbed or deposited on the membrane, the resistance of the membrane increases significantly, eventually hindering the transportation of small ions.

New strategies to overcome these challenges may be beneficial for desalination, wastewater treatment, and even food and pharmaceutical downstream processing.

### BRIEF SUMMARY

A system for redox polymer electrodialysis includes: a first electrode; a second electrode positioned in opposition to the first electrode; a pair of size-exclusion membranes positioned between the first and second electrodes; an ion exchange membrane positioned between the pair of size-exclusion membranes, the ion exchange membrane defining a feed channel and an accumulating channel between the size-exclusion membranes; and a redox channel containing the first and second electrodes and being separated from the feed and/or accumulating channels by the pair of size-exclusion membranes. The redox channel is configured for flow of a redox solution comprising a redox copolymer.

A method for redox polymer electrodialysis includes providing a system comprising: a first electrode; a second electrode positioned in opposition to the first electrode; a pair of size-exclusion membranes positioned between the first and second electrodes; an ion exchange membrane positioned between the pair of size-exclusion membranes, the ion exchange membrane defining a feed channel and an accumulating channel between the size-exclusion membranes; and a redox channel containing the first and second electrodes and being separated from the feed and/or accumulating channels by the pair of size-exclusion membranes. A redox solution including a redox copolymer is flowed through the redox channel, and water to be treated including salt and/or charged organic matter comprising ionic species is flowed through the feed channel. A voltage is applied such that the first electrode becomes positively charged and the second electrode becomes negatively charged, and the redox polymer undergoes oxidation near the first electrode and reduction near the second electrode. Consequently, the ionic species are drawn through the ion exchange membrane and the size-exclusion membrane adjacent to the feed channel, while the water remains in the feed channel. Thus, water is desalinated and/or purified.

### BRIEF DESCRIPTION OF THE DRAWINGS

FIG. 1 is a schematic of an exemplary redox polymer electrodialysis system including a pair of size-exclusion membranes; the system may be employed for desalination and/or purification of water.

FIG. 2 is another schematic of the exemplary redox polymer electrodialysis system shown in FIG. 1.

FIG. 3 is a schematic of an exemplary redox polymer electrodialysis system including multiple ion exchange membranes and multiple size-exclusion membranes so as to include multiple feed channels and multiple accumulating channels, which may be referred to as stacked channels.

FIGS. 4A-4C show the electrochemical characterization of an exemplary redox copolymer P(FPMAm-co-METAC) with molecular weight of 10,700 (“P2”); in particular, FIG. 4A shows cyclic voltammograms at different scan rates (100, 75, 50, 20, and 10 mV s−1); FIG. 4B shows cyclic stability over 1,000 CV cycles at 100 mV s⁻¹; and FIG. 4C shows a Koutecký-Levich plot and Tafel plot (inset).

FIG. 5 shows effluent concentration (mM) and pH profiles for both feed and accumulating channels in the presence and absence of the redox copolymer.

FIG. 6 shows cell voltage (V) profiles in a semi-batch system (30 mL) at the operating current of 3 mA in the presence and absence of the redox copolymer.

FIG. 7 shows desalination rate (mmol m⁻²h⁻¹) and charge efficiency (%) with respect to the concentration of redox-active unit (FPMAm) in the P(FPMAm-co-METAC).

FIG. 8 shows energy consumption (kJ mol⁻¹) with respect to the concentration (mM) of redox-active unit (FPMAm) in the redox copolymer P(FPMAm-co-METAC).

FIG. 9 shows desalination rate (mmol m⁻²h⁻¹) and charge efficiency (%) with respect to operating voltages.

FIG. 10 shows effluent pH profiles in the accumulating channel with respect to operating voltages.

FIG. 11 shows desalination rate (mmol m⁻²h⁻¹) and charge efficiency (%) at varying operating temperatures of the redox channel.

FIG. 12 shows electrochemical impedance spectroscopy at varying operating temperatures of the redox channel.

FIG. 13 shows performance of carboxylate removal via redox electrodialysis system and irreversible fouling on the anion-exchange membranes (AEMs) with only AEMs and using ferrocyanide as redox-active species.

FIG. 14 shows performance of carboxylate removal via redox polymer electrodialysis system with size-exclusion membranes, which may also or alternatively be referred to as nanofiltration (NF) membranes.

FIG. 15 shows change in membrane configuration after immersion in feed solution (2 mM carboxylates ranging from C2 to C10) and deionized (DI) water for 4 hours.

FIG. 16 shows electrochemical impedance spectroscopy (EIS) in the flow cell.

FIG. 17 shows desalination rate (mmol m⁻²h⁻¹) and the charge efficiency (%) of recycled P(FPMAm-co-METAC).

FIG. 18 shows ¹H-NMR spectra of pristine and recycled P(FPMAm-co-METAC).

FIG. 19 shows Fourier-transform infrared spectroscopy (FTIR) spectrum of a NF membrane and an ion exchange membrane (IEM) arranged between the feed channel and anodic chamber.

FIG. 20 shows distribution of negatively charged species after treating real wastewater and organic matters (octanoate, C8 and decanoate, C10) down to potable water level.

FIG. 21 shows desalination rate (mmol m⁻²h⁻¹) and total energy consumption to produce potable water from brackish (10 mM NaCl) to seawater (600 mM NaCl) via a series of redox-polymer electrodialysis.

FIG. 22 shows a techno-economic analysis of redox-polymer electrodialysis in comparison to conventional desalination technologies.

### DETAILED DESCRIPTION

A redox polymer electrodialysis system and method for the purification of fluids such as industrial wastewater, municipal wastewater, seawater, and/or brine is described in this disclosure. The redox polymer electrodialysis system includes the combination of a redox copolymer with a pair of size-exclusion membranes. This combination reduces the need for anion exchange membranes (AEMs) and enables the treatment of a wide range of charged species, from inorganic salts to charged organic substances. Consequently, the system and method may avoid membrane fouling by redox materials and organic contaminants which is associated with traditional AEMs. More specifically, in the system, the oxidation or reduction of a redox copolymer in a redox channel draws ionic species—including charged organic contaminants—across the size-exclusion membranes from a feed channel, while non-charged or bulky molecules remain in the water. The redox copolymer maintains a balance between its oxidized and reduced forms by circulating through the redox channel, facilitating steady salt removal and/or the removal of charged organic matter over time. The system and method may be used to perform continuous desalination at a lower operating potential than conventional electrodialysis and may remove a variety of charged pollutants without a crossover of redox species. Due to the high thermal stability of the redox copolymers described in this disclosure, the system may achieve stable operation at elevated temperatures.

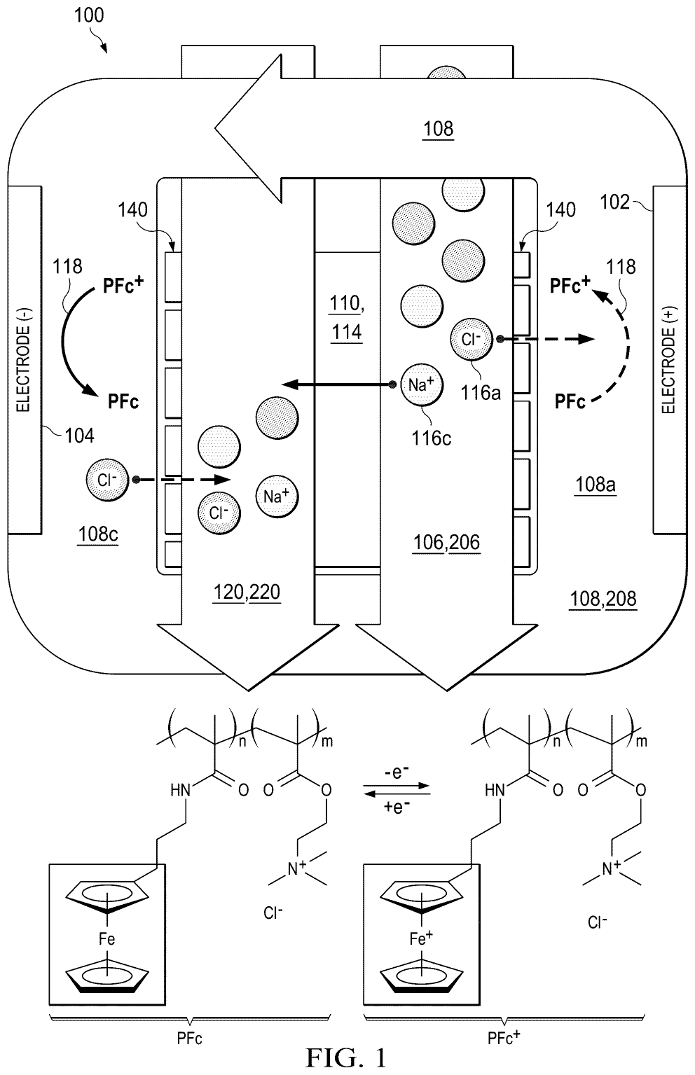

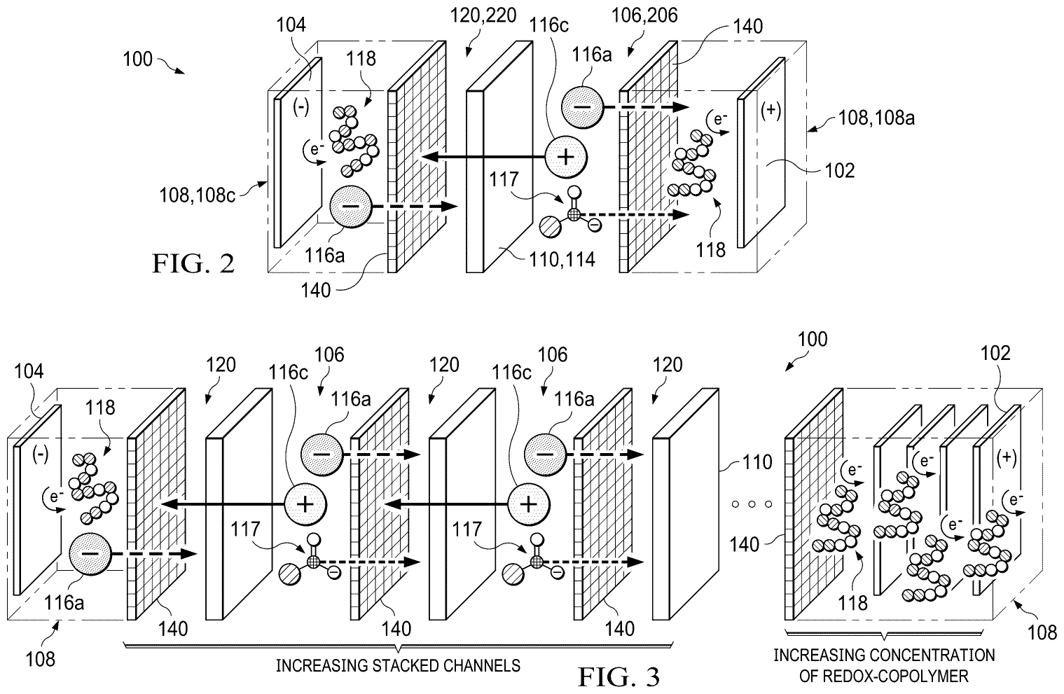

FIGS. 1 and 2 show an exemplary redox polymer electrodialysis system. In an example described below, the system includes both a feed channel and an accumulating channel, allowing for simultaneous purification of the water and collection of removed salt.

A method of desalinating and/or purifying water is described in reference to FIGS. 1 and 2. The method includes providing a system 100 including a first electrode 102, a second electrode 104 positioned in opposition to the first electrode, a pair of size-exclusion membranes 140 positioned between the first and second electrodes 102,104, and an ion exchange membrane 110 positioned between the pair of size-exclusion membranes 140. The system 100 may further include a power supply connected to the first and second electrodes 102,104 for application of a suitable voltage.

The ion exchange membrane 110 defines a feed channel 106 and an accumulating channel 120 between the size-exclusion membranes 140. The feed channel 106 extends between the ion exchange membrane 110 and one of the size-exclusion membranes 140. The feed channel 106 is configured for flow of water to be treated and the accumulating channel 120 is configured for collection of ionic species removed from the water.

The system 100 also includes a redox channel 108. The redox channel 108 is configured for continuous circulation of the redox solution 208; for example, the redox channel 108 may form a closed loop. The redox channel 108 contains the first and second electrodes 102, 104. The redox channel 108 is separated from the feed channel 106 and/or accumulating channel 120 by the pair of size-exclusion membranes 140. The redox channel 108 has a first portion (or “anion portion”) 108a extending between the first electrode 102 and the anion exchange membrane 112, and a second portion (or “cation portion”) 108c extending between the second electrode 104 and the cation exchange membrane 114.

The pair of size-exclusion membranes 140 is configured to effect separation of ionic species based on size. The pair of size-exclusion membranes 140 may have a molecular weight cut-off of 100,000 Da or less, 10,000 Da or less, 5,000 Da or less, 2,500 Da or less, or 1,000 Da or less. Additionally, the pair of size-exclusion membranes 140 may have a nominal pore size of: at least about 0.1 nm, or at least about 0.2 nm, and/or up to about 2 nm, up to about 6 nm, or up to about 10 nm. The pair of size-exclusion membranes 140 may be permeable to the ionic species but impermeable to the redox copolymer, and the separation may be independent of charge. For example, the size-exclusion membranes 140 may comprise nanofiltration membranes (NFs) and/or cellulose. The pair of size-exclusion membranes 140 may not have identical molecular weight cut-offs but alternatively may have two distinct molecular weight cut-offs.

By replacing expensive and less durable ion exchange membranes (IEMs) with size-exclusion membranes 140 such as NFs, the system may become more affordable and durable. In particular, cellulose-based size-exclusion membranes may offer a cost advantage, costing only 5-10% of the price of IEMs. Additionally, size-exclusion membranes may have a higher molecular weight cut-off than IEMs, allowing for the treatment of bulky charged organic molecules and biomolecules that cannot pass through IEMs. This approach may enable energy-efficient and continuous desalination while effectively removing charged organic matter.

The ion exchange membrane 110 may be a cation exchange membrane or an anion exchange membrane. In embodiments, the ion exchange membranes 110 may include only cation exchange membranes 114 or only anion exchange membranes 112. In an example where the ion exchange membrane is a cation exchange membrane 114 as shown in FIGS. 1 and 2, cationic species are drawn through the cation exchange membrane 114 and into the accumulating channel 120, and anionic species are drawn through the size-exclusion membrane 140 adjacent to the feed channel 106 and into the redox channel 108 prior to entering the accumulating channel 120. In an example where the ion exchange membrane 110 is an anion exchange membrane 112, the anionic species are drawn through the anion exchange membrane 112 and into the accumulating channel 120, and the cationic species are drawn through the size-exclusion membrane 140 adjacent to the feed channel 106 and into the redox channel 208 prior to entering the accumulating channel 120.

A redox copolymer 118 is dissolved in the redox solution 208 as an electrolyte. No additional electrolyte may be required. Typically, the redox solution 208 comprises water. Alternatively, the redox solution 208 may comprise an organic solvent, such as acetone, methanol, ethanol, benzene, toluene, and/or an ionic liquid. The redox channel may include the redox copolymer 118 at a relatively low concentration that may depend on the size of the electrodes and the volume of the redox channel. To avoid membrane crossover, the redox copolymer 118 may have a molecular weight above the molecular weight cut-off of the size exclusion membrane 140 such as 1,000 g/mol, above 2,500 g/mol, or above 5,000 g/mol. The molecular weight may also or alternatively be less than 100,000 g/mol, less than 70,000 g/mol, or less than 40,000 g/mol. By controlling the molecular weight or chain length of the redox copolymer 118, it may be possible to avoid membrane crossover and enhance the electrochemical kinetics and diffusion of the redox copolymer. The redox copolymer may also be designed to balance a high content of redox-active groups with high water solubility. Accordingly, the molecularly-tailored redox copolymer 118 may enable a redox polymer electrodialysis system and method that demonstrate exceptional performance and stability in effectively removing both inorganic salts and various carboxylates. Furthermore, the system and method may avoid crossover of redox materials and prevent membrane fouling.

The redox copolymer 118, which functions as a reversible redox species, may be selected for particular valorization or purification processes. The redox copolymer 118 may comprise a redox-active monomer and a water-soluble monomer. The redox-active monomer may be selected from the group consisting of: ferrocenyl-propyl-methacrylamide (FPMAm), vinyl ferrocene (VFc), ferrocenylmethyl methacrylate (FMMA), ferrocenylethyl methacrylate (FEMA), 2-(methacryloyloxy)ethyl ferrocenecarboxylate (FcMA), TEMPO methacrylate, and N-4-vinylbenzyl-N′-methyl-4,4′-bipyridinium dichloride. The water-soluble monomer may be selected from the group consisting of: [2-(methacryloyloxy) ethyl] trimethyl-ammonium chloride (METAC), poly(ethylene glycol) methacrylate (PEGMA), styrene sulfonic acid sodium salt, 3-Sulfopropyl methacrylate potassium salt, 2-Methacryloyloxyethyl phosphorylcholine (MPC), and 2-(N-3-Sulfopropyl-N,N-dimethyl ammonium)ethyl methacrylate (SBMA). A ratio of the redox-active monomer to the water-soluble monomer may be in a range from 1:1 to 1:3, from 1:1.5 to 1:2.5, or 1:2. A concentration of the redox-active monomer in the redox solution 208 may be in a range from greater than 0 mM to 2 M. For example, the concentration of the redox-active monomer in the redox solution 208 may be at least 0.1 mM, and less than 1 M, or less than 50 mM.

The redox copolymer 118 may be described as including a redox moiety connected to a polymer backbone.

The redox moiety may comprise, for example: nitroxide radicals or 2,2-diphenyl-1-picrylhydrazyl radicals, Wurster salts, quinones, compounds containing galvinoxyl radicals, phenoxyl radicals, triarylmethyl radicals, polychlorotriphenylmethyl radicals, phenalenyl radicals, cyclopentadienyl radicals, iminoxyl radicals, verdazyl radicals, nitronyl nitroxide radicals or thiazyl radicals, indigo, disulfides, thiafulvalenes, thioethers, thiolanes, thiophenes, viologens, tetraketopiperazine, quinoxaline, triarylamine, calix [4] arene, anthraquinonyl sulfide, phthalazine, cinnoline, ferrocene, carbazole, polyindole, polypyrrole, polyaniline, polythiophene, poly-N,N′-diallyl-2,3,5,6-tetraketopiperazine, 2,5-di-tert-butyl-4-methoxy phenoxy-propyl ester, poly-2-phenyl-1,3-dithiolane, poly [methanetetriletetrathio-methylene], poly-2,4-dithio-pentanylene, polyethene-1,1,2,2-tetrathiol, poly-3,4-ethylene dioxythiophene, 5,5-bismethylthio-2,2-bithiophene, poly-1,2,4,5-tetrakispropylthiobenzene, poly-5-amino-1,4-dihydrobenzo [d]-1′,2′ dithiadiene-co-aniline, poly-5,8-dihydro-1H,4H-2,3,6,7-tetrathia-anthracene, polyanthra [1′,9′,8′-b,c,d,e] [4M 0′,5′-b′,c′,d′,e′] bis-[1,6,6a6a-SIV-trithia]-pentalene, polyenoligosulfide, poly-1,2-bisthiophen-3-ylmethyldisulfane, poly-3-thienyl-methyl disulfide-co-benzyl disulfide, polytetrathionaphthalene, polynaphtho [1,8-cd] [1,2]-dithiol, poly-2,5-dimercapto-1,3,4-thiadiazole, polysulfide, polythiocyanogen, polyazulene, polyfluorene, polynaphthalene, polyanthracene, polyfuran, tetrathiafulvalene, polyoxyphenazine, and/or their isomers and derivatives.

The polymer backbone may be derived from: ethylenically unsaturated carboxylic acids or their esters or amides, such as polymethacrylates, polyacrylates or polyacrylamides, polymers derived from ethylenically unsaturated aryl compounds, such as polystyrene, polymers derived from vinyl esters of saturated carboxylic acids or derivatives thereof, such as polyvinyl acetate or polyvinyl alcohol, derived from olefins or bi- or polycyclic olefins derived polymers such as polyethylene, polypropylene or polynorbornene, derived from imide-forming tetracarboxylic acids and diamines derived polyimides of naturally occurring polymers and their chemically modified derivatives, polymers such as cellulose or cellulose ethers, and polyurethanes, polyvinyl ethers, polythiophenes, polyacetylene, polyalkylene glycols, poly-7-oxanorbornene, polysiloxanes, and/or polyalkylene glycol and their derivatives, such as their ethers, preferably polyethylene glycol and derivatives thereof.

In an embodiment, the redox copolymer 118 may comprise a water-soluble ferrocene-based redox copolymer, such as a copolymer of ferrocenyl-propyl-methacrylamide and [2-(methacryloyloxy) ethyl] trimethyl-ammonium chloride or P(FPMAm-co-METAC). Experiments described below confirm that the redox copolymer P(FPMAm-co-METAC) has remarkable electrochemical reversibility, electron-transfer rate, and mass-transfer.

Returning again to FIGS. 1 and 2, the method for redox polymer electrodialysis includes flowing a redox solution 208 comprising the redox copolymer 118 through the redox channel 108 and flowing water to be treated 206 (that is, water which may include salt and/or charged organic matter comprising ionic species) through the feed channel 106. The flow rates of the water to be treated 206 and the redox solution 208 through the respective channels 106,108 may depend on factors such as the volume of each channel and the operating voltage. One or more pumps may be connected to the feed, redox, and/or accumulating channels 106,108,120 to control the flow rate of the fluids 206,208,220 through the channels 106,108,120. For the exemplary system shown in FIGS. 1 and 2, flow rates in a range from about 0.5 mL/min to about 20 mL/min for the water to be treated 206 and the redox solution 208 may be suitable.

The water to be treated 206 may comprise industrial wastewater, municipal wastewater, seawater, and/or brine. As indicated above, the water may include salt and/or charged organic matter 117 comprising ionic species. The ionic species may include cationic species comprising cations and/or cationic organic species; and anionic species comprising anions and/or anionic organic species. In some examples, the anions may comprise Li⁺, Na⁺, K⁺, Mg²⁺ and/or Ca²⁺, and the cations may comprise Cl⁻, NO₃⁻ and/or SO₄²⁻. The cationic or anionic organic species may comprise, for example, carboxylate(s), organic acid(s), fatty acid(s), per- and polyfluoroalkyl substances (PFAS), and/or surfactant(s).

To effect purification, a voltage is applied such that the first electrode 102 takes on a positive charge (becomes a positive electrode) and the second electrode 104 takes on a negative charge (becomes a negative electrode). That is, a positive voltage is applied to the first electrode 102. The applied voltage catalyzes oxidization or reduction of the redox copolymer 118 in the redox channel 108. More particularly, the redox copolymer 118 undergoes oxidation near the first (positive) electrode 102, i.e., in the anion portion 108a of the redox channel 108, and reduction near the second (negative) electrode 104, i.e., in the cation portion 108c of the redox channel 108.

The voltage applied to catalyze the redox reactions may be less than the voltage required for the water-splitting reaction (greater than 1.2 V) used in conventional electrodialysis, where water is split into hydroxide ions and protons. For example, the voltage applied in the redox polymer electrodialysis system 100 may be less than 1.2 V, or less than 1 V, and as low as 0.6 V as shown here, or even as low as 0.4 V in some examples. Experiments described below evaluated salt removal at various operating voltages, and it was found that a higher operating voltage (e.g., greater than 0.6 V, or from 0.6 V to 0.8 V) may be effective for increasing both salt removal and accumulation were significantly increased (e.g., by at least 69% and 119%, respectively, as discussed in the examples below). As demonstrated below, energy consumption may be maintained at less than 90 kJ/mol_{NaCl}, more specifically at around 80 kJ/mol_{NaCl} or less, while achieving desalination and/or purification of the water.

The method may further include maintaining the redox solution 208 at a temperature above 25° C. and less than 100° C., preferably greater than 30° C., greater than 50° C., or greater than 70° C. The desalination performance may be enhanced at higher electrolyte temperatures (e.g., 60° C. or higher), allowing for new operation modes that integrate waste-heat sources. This is facilitated by the thermal stability of the redox copolymer, enabling efficient utilization of heat energy.

In the system 100 shown in FIGS. 1 and 2, the anions (e.g., Cl⁻) 116a and negatively charged organic matter move through the size-exclusion membrane 140 towards the positive electrode 102, entering the anion portion 108a of the redox channel 108. Similarly, the cations (e.g., Na⁺) 116c move through the cation exchange membrane 114 towards the negative electrode 104, entering the accumulating channel. The redox copolymer 118 circulates through the redox channel 108 during the application of the voltage, undergoing oxidation near the first electrode 102 (in the anion portion 108a) and reduction near the second electrode 104 (in the cation portion 108c), allowing for continuous removal of the ions and charged organic matter 117 from the feed channel 106. Since the redox channel 108 and the feed channel 106 are separated by an ion exchange membrane 110 and a size-exclusion membrane 140, the redox copolymer 118 cannot pass over into the feed channel 106 and remains in the redox channel 108. The ionic species drawn through the ion exchange and size-exclusion membranes 110,140 may enter the accumulating channel 120 either indirectly (by passing through the redox channel 108 first) or directly for recovery.

This process results in the desalination and/or purification of the water, wherein at least about 95% or at least about 99% of the salt and/or charged organic matter may be removed from the water passing through the feed channel 106.

This system is not limited to the negatively charged organic matter 117 illustrated in FIG. 2, but can be generalized to treat any charged organic matter. In the case of positively charged organic contaminants, the direction of ion flow can be controlled by replacing the cation exchange membrane 114 of FIGS. 1 and 2 between the feed and accumulating channels 106,120 with an anion exchange membrane, as described above. This generalized strategy allows advancing electrodialysis technologies for a wide range of industries for treating inorganic ions and charged organic contaminants.

The ionic species, in particular, the charged organic matter 117 removed from the water 206 in the feed channel 106, may be collected in a subsequent regeneration process. (The removed salt may be collected in the accumulating channel 120 as mentioned above.) The regeneration process may commence after sufficient purification of the water to be treated 206 (e.g., after at least about 95% salt removal, or at least about 99% salt removal), at which time the flow of the water to be treated 206 through the feed channel 106 and/or the positive applied voltage may be halted.

As shown in FIG. 3, the system 100 may include multiple ion exchange membranes 110 and multiple size-exclusion membranes 140 so as to include multiple feed channels 106 and multiple accumulating channels 120. The ion exchange membranes 110 are positioned alternately with the size-exclusion membranes 140 between the first and second electrodes 102,104. Generally speaking, the system may include up to n of the pairs of size-exclusion membranes 140 and up to n+1 of the ion exchange membranes 110, where n is an integer. The anion and cation exchange membranes 112,114 may be obtained from any of a number of commercial sources. Cation exchange membranes 112 typically comprise a polymer film including negatively-charged functional groups, while anion exchange membranes 114 typically comprise a polymer film including positively-charged functional groups.

It is also contemplated that the system 100 may include a stack of two or more of the first electrodes 102 (as illustrated in FIG. 3) and a stack of two or more of the second electrodes 104, allowing for higher water production rate to be achieved without significantly increasing the size of the system 100. Suitable first and second electrodes 102,104 for the system 100 may be carbon-based or made of another electrically conductive material.

The system 100 utilizes a reversible redox reaction at a lower operation voltage than the water-splitting reaction employed in electrodialysis, as indicated above, thereby enabling an energy-efficient operation.

### Synthesis of P(FPMAm-co-METAC)

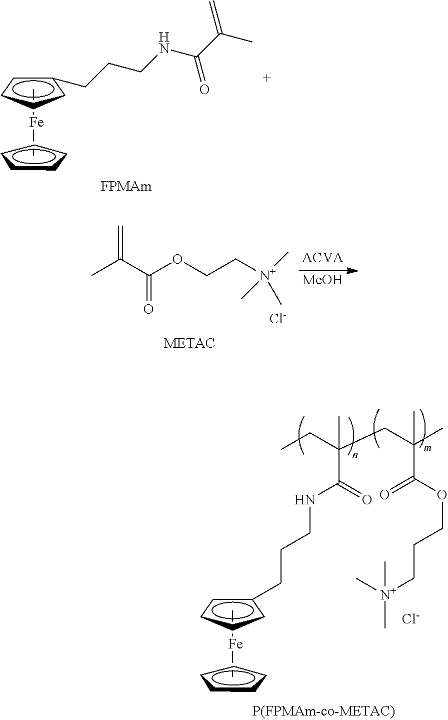

As illustrated above, an exemplary water-soluble redox copolymer, P(FPMAm-co-METAC), may be synthesized by free-radical copolymerization of ferrocenyl-propyl-methacrylamide (FPMAm) and [2-(methacryloyloxy) ethyl] trimethyl-ammonium chloride (METAC). In the illustration, ACVA represents 4,4′-Azo-bis-(4-cyanovaleric acid). In the redox copolymer, FPMAm contributes a redox-active ferrocene moiety to the copolymer, while METAC is necessary to achieve water solubility of hydrophobic ferrocene moiety. The polymers contained 66-69 mol % of METAC to balance a high content of redox-active groups with excellent water solubility.

TABLE 1
Characteristic properties at varying polymer chain lengths

| | | | FPMAm | | | | | |
|---|---|---|---|---|---|---|---|---|
| | ACVA | Temperature | content^{b} | Yield | M_{w}^{c} | E_{1/2} ^{d} | D ^{d} | k^{o e} |
| Polymer | [mol %] | [° C.] | [%] | [%] | [g mol⁻¹] | [V] | [cm² s⁻¹] | [cm s⁻¹] |
| P1^{a} | 5 | 80 | 31 | 67 | 2,180 | 0.180 | 2.75 × 10⁻⁶ | 1.68 × 10⁻⁴ |
| P2 | 5 | 80 | 33 | 81 | 10,700 | 0.205 | 2.38 × 10⁻⁶ | 2.16 × 10⁻³ |
| P3 | 1 | 60 | 34 | 83 | 64,100 | 0.208 | 4.67 × 10⁻⁷ | 5.39 × 10⁻³ |

^{a}10 mol % of 2-mercaptoethanol was added as the chain-transfer agents
^{b}Analyzed by NMR
^{c}Determined by GPC in H₂O with 0.1M NaCl + 0.1% trifluoroacetic acid and poly(2-vinylpyridine) calibration
^{d} Determined by CV (vs. Ag/AgCl in 3M KCl)
^{f)} Analyzed by RDE.

### Electrochemical Analysis of P(FPMAm-co-METAC)

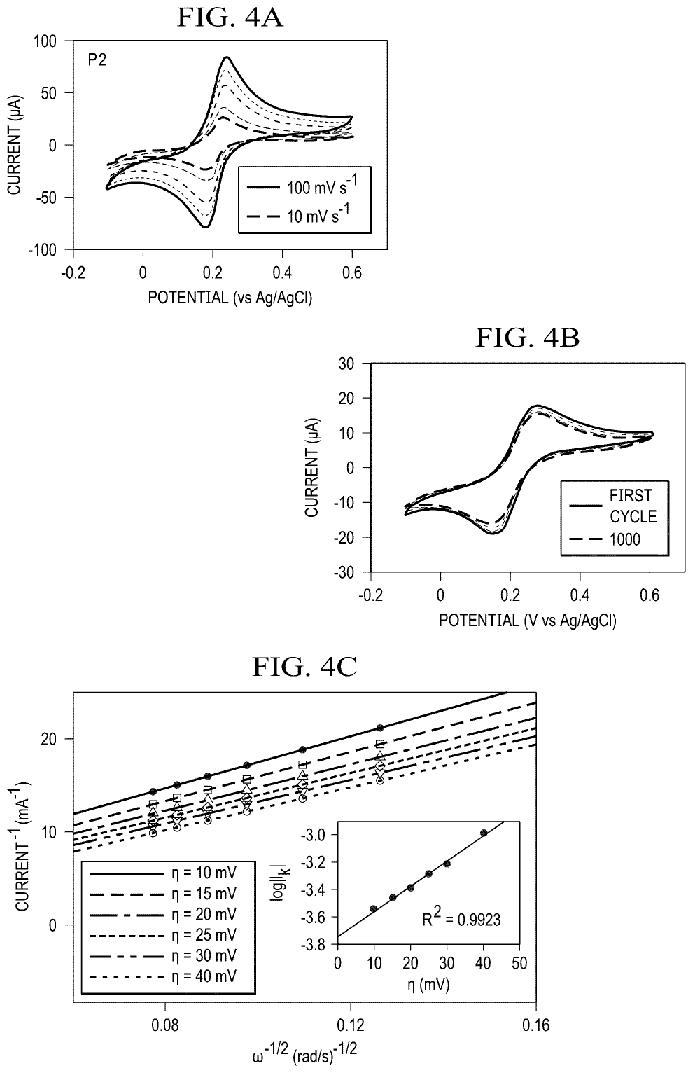

By variation of polymerization conditions, three different molecular weights of 2,180 (P1), 10,700 (P2), and 64,100 (P3) g mol⁻¹ were prepared (Table 1), and then the electrochemical capabilities were investigated using cyclic voltammetry (CV) and rotating-disc electrode (RDE) characterization (FIG. 4). The CV measurements were conducted using 5 mM of redox-active substances (Fc concentration) and 1 M NaCl with IR compensation. Pt wire was used as both working and counter electrodes, and Ag/AgCl (3M KCl) was used as a reference electrode. FIG. 4A shows cyclic voltammograms of P2 at different scan rates (100, 75, 50, 20, and 10 mV s⁻¹), revealing that P(FPMAm-co-METAC) has remarkable reversibility between ferrocene and ferrocenium states regardless of the chain lengths. FIG. 4B shows cyclic stability of P2 over 1,000 CV cycles at 100 mV s⁻¹, revealing that there is a negligible change in the redox peak over 1,000 CV cycles and indicating stable reversibility of the redox-active ferrocene unit in an aqueous electrolyte. FIG. 4C shows the Koutecký-Levich plot and Tafel plot (inset).

On the other hand, the diffusion coefficients (D), and electron-transfer rate constants (k⁰) largely depended on the polymer chain lengths (Table 1). In general, as the polymer chain length increases, the diffusion coefficient D decreases, while the electron-transfer rate k⁰ constant increases. As the polymer size (M_{w}) increased from 2,180 g mol⁻¹ (P1) to 64,100 g mol⁻¹ (P3), the diffusion coefficient (D) decreased from 2.75×10⁻⁶ cm²s⁻¹ to 4.67×10⁻⁷ cm²s⁻¹. The inverse relationship between polymer size and D can be attributed to two effects represented within the Stokes-Einstein equation: i) the increase in viscosity of the solution with increasing chain length and ii) the slower diffusion with an increase in molecular size. As for the electron-transfer rate constants, slight differences in k⁰ was observed, which may be attributed to the different level of redox-active contents within the copolymer (%).

In this synthesis, the measured PMAm content in P1, P2, and P3 was 31, 33, and 34 mol % FPMAm, respectively (Table 1). The incremental trend in mol % of redox-active ferrocene in copolymer resulted in a slightly enhanced k⁰ value of 1.68×10⁻⁴, 2.16×10⁻³, and 5.39×10⁻³ cm s⁻¹ for P1, P2, and P3, respectively. Overall, diffusion coefficient and electron-transfer rate constants of P(FPMAm-co-METAC) are comparable with widely used redox-active small molecules (e.g., vanadium, oxovanadium, and ferrocyanide) and ferrocene-based small molecules (e.g., ferrocenyl-methyl trimethylammonium chloride). Especially, P(FPMAm-co-METAC) reveals one or two magnitude higher diffusion and kinetic properties than current state-of-art water-soluble redox polymers such as TEMPO-based polymer (D=7.0×10⁻⁸ cm²s⁻¹; k⁰=4.5×10⁻⁴ cm s⁻¹) and viologen-based polymer (D=7.6×10⁻⁷ cm²s⁻¹; k⁰=9×10⁻⁵ cm s⁻¹). Considering both notable intrinsic properties (D=2.38×10⁻⁶ cm²s⁻¹; k⁰=2.16×10⁻³ cm s⁻¹) and synthesis yields (81% and 91% for a small and large batch, respectively), P2 was selected for proof-of-concept redox polymer electrodialysis system due to its optimal electrochemical and mass transfer properties.

### Desalination Performance of Redox Polymer Electrodialysis System

For running redox polymer electrodialysis, P(FPMAm-co-METAC) was dissolved in water and circulated in the cathode and anode compartments (redox channel or “RC”) in a closed-loop for the continuous regeneration of both oxidized and reduced redox species. The RC was separated by a cellulose-based nanofiltration (NF) membrane with a molecular weight cut-off of 1,000 g mol⁻¹, and a cation-exchange membrane (CEM) was used between the feed channel (FC) and accumulating channel (AC). When the redox copolymer is oxidized/reduced, the redox copolymer is retained by the size-exclusion NFs, providing the direction of ion movement without AEMs. For instance, chloride from the FC entered the anodic side of the RC, while sodium enters the accumulating channel (AC) to balance out the chloride leaving the FC. As chloride circulates from the anodic to the cathodic compartment, chloride in the RC entered the AC to balance the charge neutrality with the cations settled in AC because the redox copolymer cannot cross-over the NF.

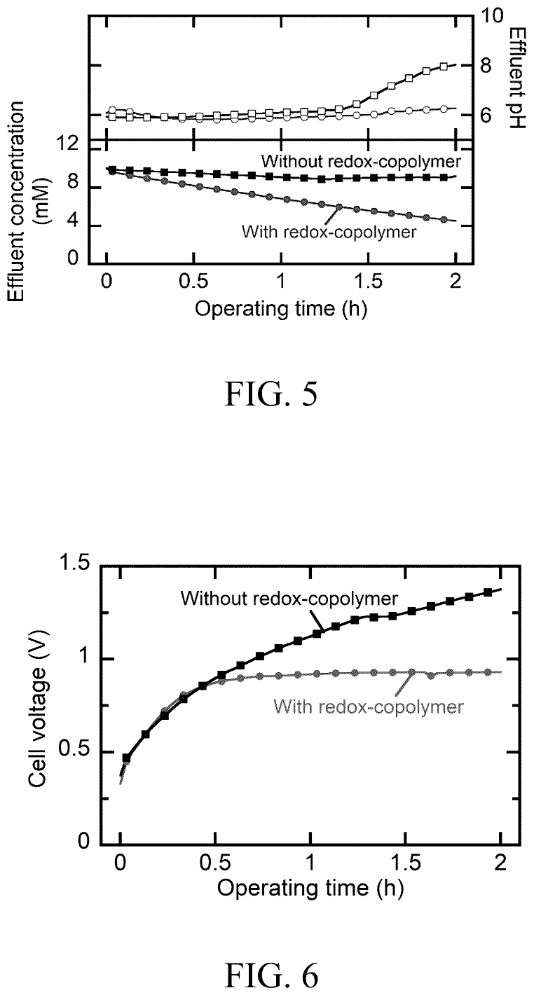

To highlight the mechanism of action of the redox copolymer during the desalination, chronopotentiometry experiments were conducted in the presence (30 mM FPMAm equivalents) or absence of the redox copolymer under the same ionic concentration (30 mM NaCl) (FIGS. 5 and 6). Referring to FIG. 5, the redox polymer electrodialysis exhibited 55% salt removal over 2 hours without any pH changes, indicating the absence of parasitic reactions; whereas, only 8% of salt was desalinated in the absence of the redox copolymer. The exceptional salt removal performance of redox polymer electrodialysis was attributed to the effective retention of the polymer by the NF membranes (or size-exclusion membranes), thus controlling the direction of ion migration. In the absence of a redox copolymer, back diffusion was more pronounced due to the permeability of hydrogen and hydroxide through both the nanofiltration and ion-exchange membranes, which cannot effectively control the direction of ion transport, particularly in a single unit cell that contains only one FC and one AC. Referring to FIG. 6, redox polymer electrodialysis reduced 88% of energy consumption (110 kJ mol_{NaCl}⁻¹) compared to electrodialysis without the redox copolymer (890 mol_{NaCl}⁻¹) due to the remarkable salt removal performance and low output voltage (<0.92 V).

### Effect of Operating Parameters

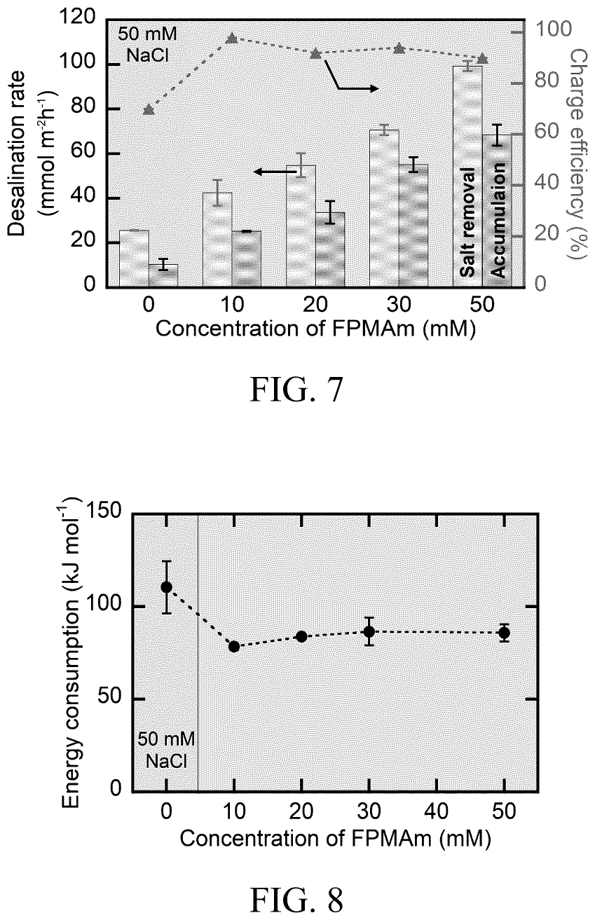

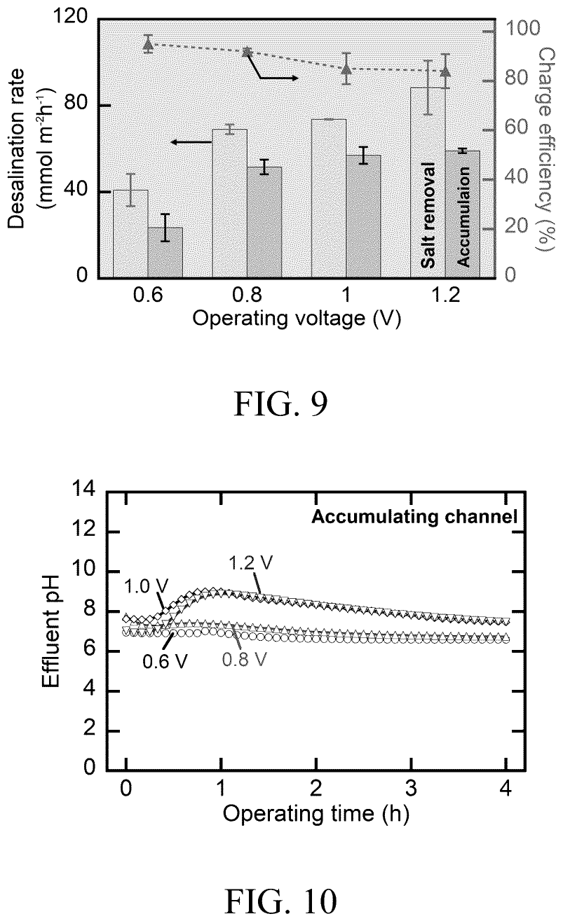

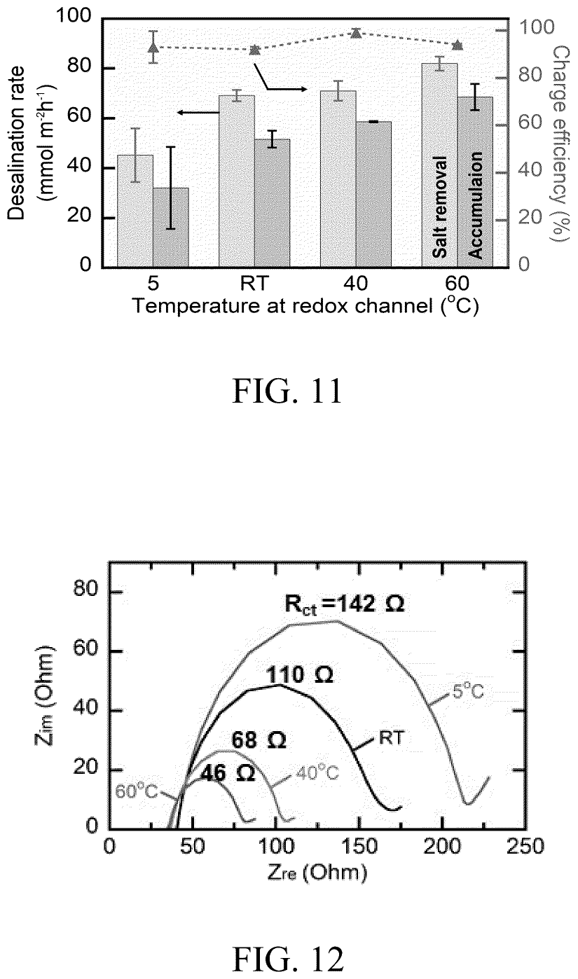

The redox polymer electrodialysis system was evaluated under various operating conditions such as redox copolymer concentrations (0-50 mM FPMAm equivalents) (FIGS. 7 and 8), operating voltages (0.6-1.2 V) (FIGS. 9 and 10), and electrolyte temperatures (5-60° C.) (FIGS. 11 and 12).

### Redox Copolymer Concentrations

Referring to FIG. 7, a linear trend was observed between the concentration of FPMAm (redox-active monomer) and the desalination performance. At 0 mM FPMAm (i.e., no redox copolymer), the system removed the salt at a rate of 25.6 mmol_{NaCl} m⁻²h⁻¹. With 50 mM FPMAm, the system exhibited 3.9 times higher desalination performance and removed the salt at a rate of 99.3 mmol_{NaCl} m⁻²h⁻¹. In addition, the charge efficiency was significantly increased from 70% (0 mM FPMAm) to an average of 93% in the presence of the redox copolymer.

Referring to FIG. 8, the energy consumption at 0 mM FPMAm was 110 kJ mol⁻¹, while the energy consumption in the presence of redox copolymer was between 78-88 kJ mol⁻¹. Both 0 mM FPMAm (50 mM NaCl) and 50 mM FPMAm were operated under the same ionic concentration in the redox channel (ionic concentration of 100 mM). These results indicate that the redox polymer electrodialysis system can treat water with lower energy consumption than the conventional ED, through the replacement of the water-splitting reaction (>1.2 V) with a redox reaction (0.8 V in this study).

### Operating Voltages

Referring to FIG. 9, the increase in the operating voltage from 0.6 V to 1.2 V resulted in a higher salt removal rate from 40.9 to 88.3 mmol_{NaCl} m⁻²h⁻¹ and an accumulation rate from 23.5 to 59.2 mmol_{NaCl} m⁻²h⁻¹. Especially when the operating voltage increased from 0.6 V to 0.8 V, both the salt removal and accumulation were significantly increased by 69% and 119% in the FC and AC, respectively. However, there is a trade-off between desalination performance and charge efficiency due to the presence of side reactions at higher operating voltage. As the operating voltage was varied from 0.6 V to 1.2 V, the charge efficiency decreased from 95% to 84%.

Referring to FIG. 10, the presence of water-splitting reactions resulted in the change of effluent pH of the AC at the operating potential≥1.0 V. Both charge efficiency and pH change explain that the presence of side reactions, mainly water splitting, increases the energy consumption and might even change the water quality due to the pH change. In this regard, 0.8 V was thought to be the optimal operating voltage with lab-scale system.

### Electrolyte Temperatures

Referring to FIG. 11, the electrolyte temperature has also been found to have a great influence on the performance of the redox polymer electrodialysis system. As the electrolyte temperature was increased from room temperature (RT ˜21° C.) to 60° C., 1.19- and 1.33-times higher salt removal and accumulation rates were achieved. On the other hand, when the electrolyte temperature decreased from RT to 5° C., the performance significantly decreased by 35% and 38% for salt removal and accumulation rates, respectively. Compared with the results in FIGS. 7 and 9, the desalination performance at 60° C. (salt removal rate of 81.2 mmol_{NaCl} m⁻²h⁻¹ at 0.8 V with 30 mM FPMAm) is equivalent to the room temperature performance at the operating potential of around 1.1 V (30 mM FPMAm) or with 40 mM FPMAm (at 0.8 V). This suggests the potential for integration with heat sources or deployment in environmentally hotter locations to enhance desalination performance through improved reaction kinetics.

To understand the effect of electrolyte temperature on the desalination performance, the charge-transfer resistance (R_{ct}) of the system was measured at varying electrolyte temperatures. As FIG. 12 illustrated, the increase in electrolyte temperature from 5° C. to 60° C. substantially reduced the R_{ct} from 142 to 46Ω. The decrease in R_{ct} allows the enhancement of redox reaction kinetics for the P(FPMAm-co-METAC), enabling a greater amount of salt removal and accumulation. Thus, the proven thermal stability of the redox polymer can be leveraged for the development of a robust water-energy nexus system. For example, the integration with waste heat from industrial boilers, which accounts for 78% of low to medium-grade waste heat, could potentially enhance the desalination performance, eliminating the need for higher operating voltage or increased polymer content. In addition, the thermal stability of redox copolymer makes the system especially suited for hotter climate regions such as the Middle East, which present an urgent demand for energy-efficient water desalination.

Throughout the parametric studies, the redox copolymer was not detected in either the FC and AC, highlighting that the redox copolymer does not crossover or contaminate the diluate and concentrate. This result confirms the exceptional polymer retention by the size-exclusion membranes and their remarkable chemical stability.

### Stability and Performance of Redox Polymer Electrodialysis System

An exemplary redox copolymer electrodialysis was shown to enable the removal of a wide range of organic species, by leveraging NFs (the size-exclusion membranes) with a molecular-weight cutoff of 1,000 g mol⁻¹ (1 kDa). The organic fouling formation is largely affected by the size and hydrophobicity of foulants and membrane structure. Thus, various chain lengths of carboxylates (acetate, C2 to decanoate, C10) were selected as representative organic foulants found in both natural and wastewater. Then the performance of organic removal was compared with the redox electrodialysis with commercial AEMs.

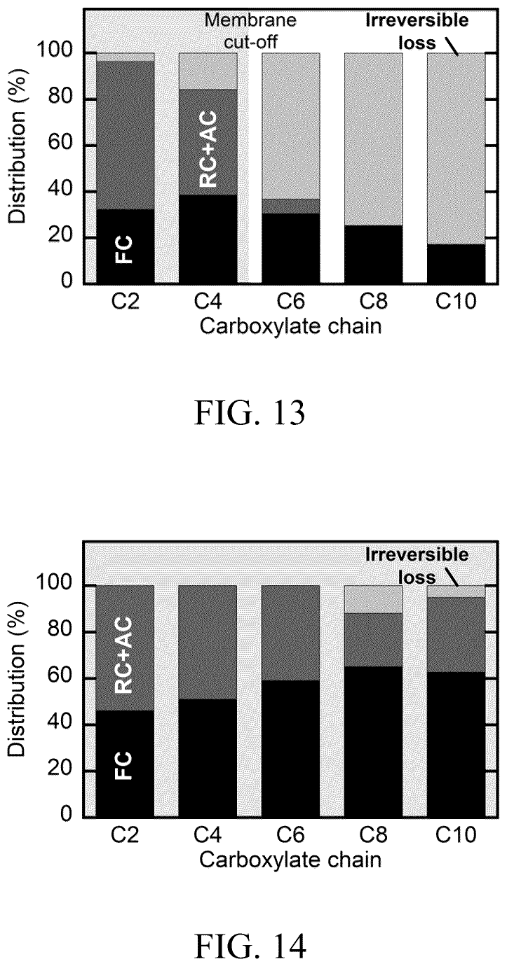

Referring to FIG. 13, the redox electrodialysis with AEMs showed a bottleneck to treat organic species larger than C6 due to irreversible bindings to the membrane. On the other hand, referring to FIG. 14, the nanofiltration-coupled redox polymer electrodialysis system successfully treated the organic anions regardless of the chain lengths of carboxylates. The results indicate that the commercial AEM has limited capability of large organic separations compared with size-exclusion membranes such as NFs, and the AEM cut-off might present between butanoate (C4) and hexanoate (C6).

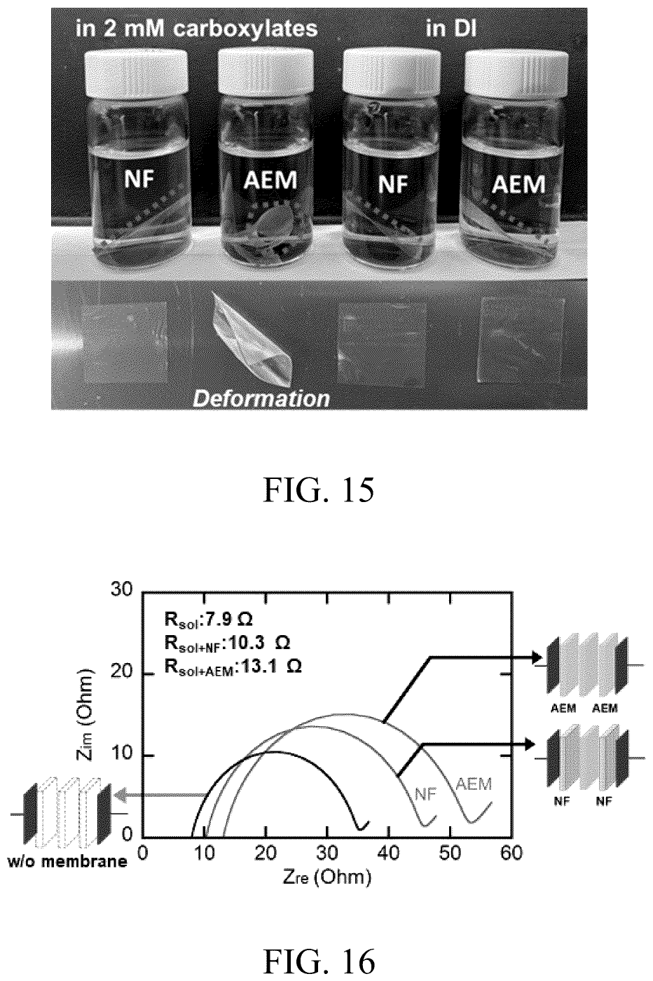

Moreover, over 70% of longer-chain carboxylates (C6-C10) were irreversibly adsorbed on the commercial AEMs during electrochemical operation. Referring to FIG. 15, this irreversible adsorption caused membrane fouling and even deformation. This aligns with observations that AEMs are more susceptible to fouling formation than the cation exchange membranes (CEMs), by prevailing negatively charged organic species including but not limited to carboxylic acids and surfactants. The quaternary ammonium group and hydrophobic polymer backbone on the anion-exchange membrane interact with organic molecules through electrostatic and hydrophobic attractions. In this experiment, as the carboxylate chain becomes longer, the increase in the hydrophobicity of carboxylate results in a stronger interaction with the polymer backbone of the AEMs. The strong binding causes irreversible adsorption of carboxylates on the membrane and pH changes in the AC, indicating the presence of side reactions. On the other hand, the nanofiltration-coupled redox polymer electrodialysis system can remove organic species without any noticeable fouling formation on the cellulose-based NF, highlighting extended applications in downstream water remediation which contain charged organic contaminants such as carboxylates and organic acids.

Moreover, the size-exclusion membranes presented low resistances compared to AEMs as shown in FIG. 16. The system resistance was measured in the presence of the membranes (R_{sol+AEM}), and without any membranes (Rₛₒₗ) using the same salt concentration (50 mM) throughout the RC, FC, and AC to disregard mixing and diffusion effects. The use of size-exclusion membranes significantly reduced the overall cell resistance by 24%, compared to the equivalent system with AEMs in place (R_{NF}=2.4Ω, R_{AEM}=5.2Ω). In general, the ion-exchange membrane is made up of polymeric supports and functional groups (e.g., sulfonic acid, carboxylic acid, and quaternary ammonium), while the NF is made up of cellulose. The non-functionalized structure and the larger pore size of size-exclusion membranes facilitate mass transport of ions and decrease membrane resistance. Consequently, the decrease in membrane resistance enhances the charge efficiency and lowers the energy consumption to treat molecules such as carboxylates.

### Long-Term Stability of Redox Polymer Electrodialysis System

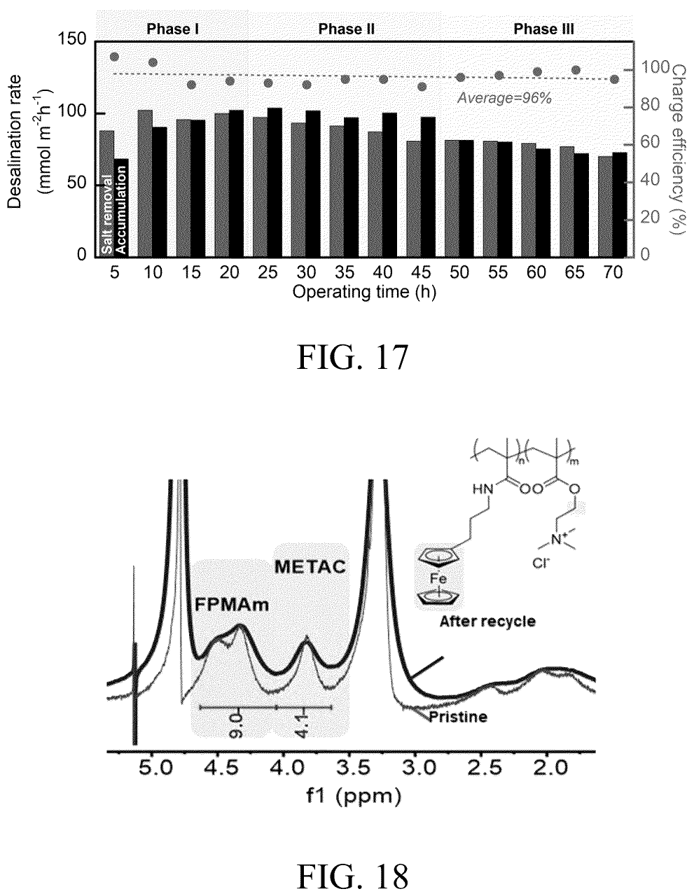

To evaluate the long-term operation feasibility of redox polymer electrodialysis system and highlight the reusability of the redox copolymer, a continuous desalination performance was further examined over a 70-hour operation using recycled P(FPMAm-co-METAC) from previous experiments (FIG. 17). The long-term desalination performance was averaged for every 5 hour-operation. Prior to the long-term operation, the recycled redox copolymer maintained a copolymer ratio of P(FPMAm₃₃-co-METAC₆₇) (FIG. 18) and electrochemical properties. Accounting for the exceptional stability and redox activity of the iron-cyclopentadienyl bond (Fe-Cp), the feed stream was continuously desalinated with an average salt removal rate of 86.8 mmol_{NaCl} m⁻²h⁻¹. A slight increase in salt removal was observed within the first 20 hours of the operation (Phase I), mainly due to the lower system resistance with a fraction of the desalted salts remaining in the RC. As the salt concentration in the RC became saturated and increased the osmotic pressure, the concentrated salt in the RC tends to accumulate in the AC, resulting in greater salt accumulation than the desalinated salt (Phase II). Eventually, both the salt removal and accumulation were equilibrated around 77.0 mmol_{NaCl} m⁻²h⁻¹ (Phase III). Going forward to consistent desalination and accumulation, optimizing the retention time could potentially lower osmotic effects, and enhance the long-term desalination performance. Despite stable redox activity throughout the 70-hour operation and long-term stability observed in the redox-flow battery system, the redox copolymer may still be susceptible to a possible failure mechanism of loss of its water-soluble moiety (METAC) under basic conditions. In the presence of a water-splitting reaction, trimethyl ammonium can be readily replaced by hydroxide or eliminated via Hofmann elimination. However, referring to FIG. 17, throughout the long-term operation, the energy consumption and charge efficiency were maintained at around 80 kJ mol⁻¹ and 96%, respectively. Also, a constant pH in the FC was observed without any polymer being detected in neither the FC nor AC, indicating the robustness of the redox polymer electrodialysis system and stability of the redox copolymer in a long-term operation.

### Practicality of Redox Polymer Electrodialysis System for Treating Real Wastewater to Potable Water

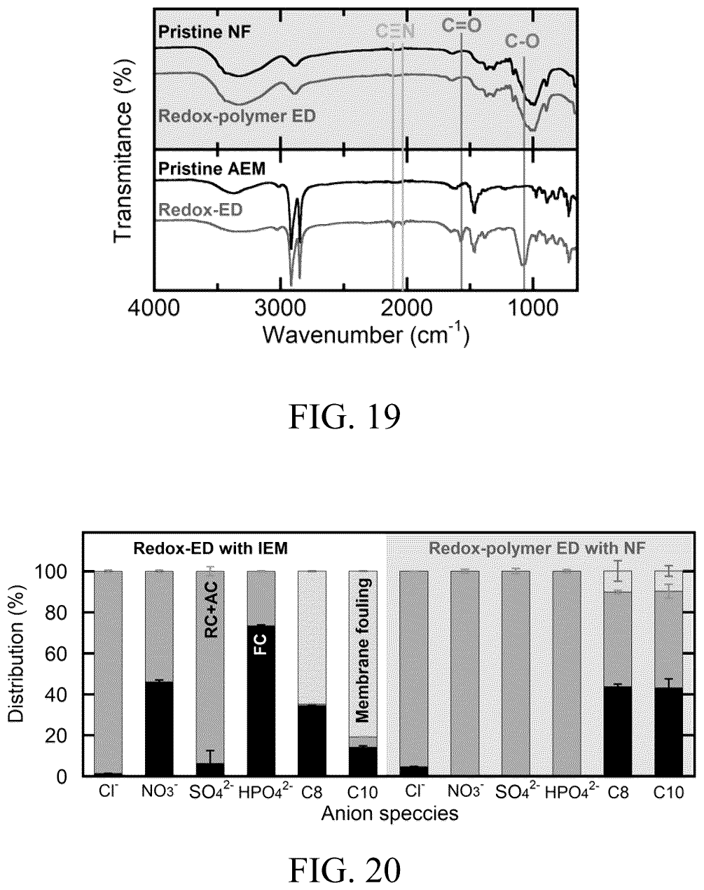

Further investigations were conducted to assess the practicality of redox polymer electrodialysis for treating real wastewater to potable water. Wastewater was collected from the Decatur wastewater treatment facility in Illinois after primary treatment with clarifiers. In addition to a variety of inorganic cationic and anionic species present in the wastewater, the model organic pollutants (1 mM of octanoate and decanoate) were introduced to the system to investigate fouling behavior in comparison to the redox electrodialysis with ion-exchange membranes (FIGS. 19 and 20). Chloride distribution contains the initial concentration from wastewater, 10 mM Cl⁻¹ from the AC. In the case of redox-polymer ED, there is also an extra 55 mM of Cl⁻¹ from the counter-anion of P(FPMAm-co-METAC).

Both redox electrodialysis with IEM and redox polymer electrodialysis with NF achieved the production of potable water level salinity with the comparable energy consumption of 86 kJ molₜₒₜₐₗ₋ᵢₒₙ₋ᵣₑₘₒᵥₐₗ⁻¹ and 118 kJ molₜₒₜₐₗ₋ᵢₒₙ₋ᵣₑₘₒᵥₐₗ⁻¹, respectively. Especially, redox polymer electrodialysis demonstrated remarkable resistance to membrane fouling by organic species and redox mediators at a faster ion removal rate than the redox-electrodialysis (FIG. 19). On the other hand, redox electrodialysis with IEM suffered from severe membrane fouling or physical deformation caused by carboxylates and ferri/ferrocyanide. In particular, the AEM between the anodic chamber and the FC displayed distinct Fourier-transform infrared spectroscopy (FTIR) peaks for CEN (2030 and 2110 cm⁻¹), C═O (1600 cm⁻¹), and broad C—O stretching (1025-1160 cm⁻¹), which indicates the presence of carboxylate groups and redox mediators (ferri- and ferrocyanide). As confirmed by membrane digestion, over 60% of organic species were irreversibly adsorbed on the AEMs (FIG. 20). When the organic species and redox mediators accumulate on a membrane surface, they not only obstruct the ion-exchange pathways but also generate an electrical barrier that impedes the ionic movement across the membrane. Consequently, redox polymer electrodialysis enabled the production of potable water 5.6 hours faster than the redox electrodialysis with IEM. Although the presence of magnesium and calcium in the wastewater increases the likelihood of scaling of the CEM, their concentration in the wastewater is relatively low (less than 9% of the total cation composition of the wastewater). Therefore, the desalination efficiency was not affected by the divalent cations for both I EM-integrated redox electrodialysis and NF-integrated redox polymer electrodialysis, and there was no apparent deformation or scaling observed on the CEM. Operating both redox-mediated electrodialysis systems below the water-splitting reaction potential (<1.0 V) can also reduce the likelihood of scaling formation or precipitation of divalent cations. Overall, the redox polymer electrodialysis exhibits remarkable potential for treating wastewater down to potable water level even in the presence of charged organic species.

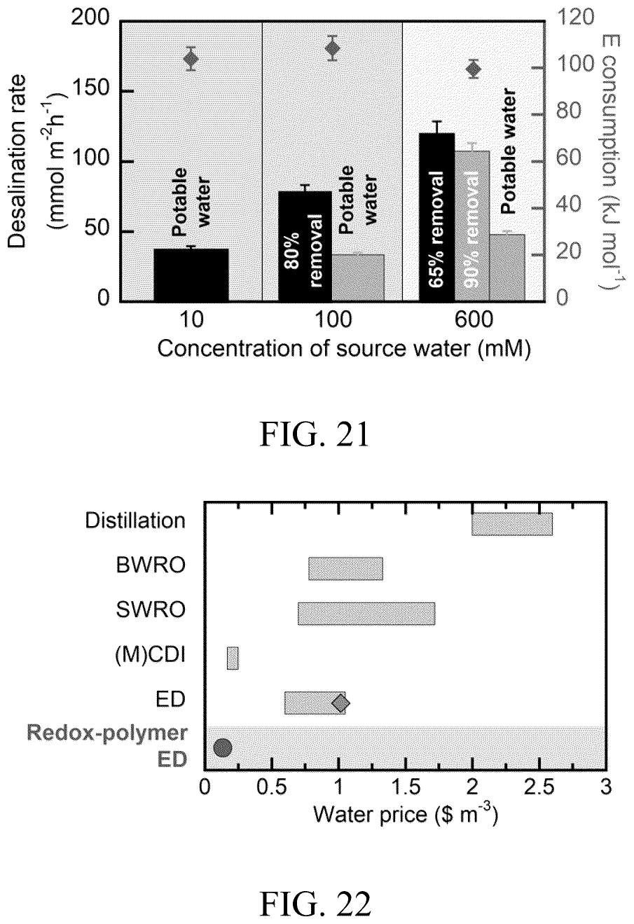

FIG. 21 shows how desalination rate (mmol m⁻²h⁻¹) and total energy consumption to produce potable water from brackish (10 mM NaCl) to seawater (600 mM NaCl) via a series of redox-polymer electrodialysis. The first salt removal for 10 mM, 100 mM (80% salt removal), and 600 mM (65% salt removal) was performed in a sequential process without changing the electrolyte or system assembly. It was also discovered that the redox polymer electrodialysis can effectively desalinate a wide range of source water salinities, from brackish (10 mM) to seawater (600 mM) in a series without electrolyte change or additional system assembly. Referring to FIG. 21, for desalination of 10 mM down to potable water (conductivity below 500 μS/cm), the system achieved an average desalination rate of 37.7 mmol m⁻²h⁻¹ with an energy consumption of 104 kJ mol⁻¹. This desalination rate increased by 2- and 3-fold with higher feed salinity of 100 mM and 600 mM due to the reduced system resistance from high feed salinity and the remaining salts in the electrolyte. The use of nonselective NFs caused a fraction of the desalted salts to accumulate in RC. Consequently, the presence of remaining salts in the RC facilitated desalination, leading to a higher desalination rate and lower energy consumption. However, treating high-salinity source water down to potable water in a single cycle poses a challenge for the redox polymer electrodialysis system due to high back diffusion. While the current state-of-the-art redox polymer electrodialysis system is well-suited for brackish water desalination, it has been shown that the system can also achieve energy-efficient desalination of high-salinity source water to produce potable water through a sequential process (FIG. 21). The use of a cascade process to treat high salinity levels improved the overall desalination rate while maintaining the total energy consumption relatively similar to or even lower than the energy required to treat brackish water (10 mM). This observation highlights the flexibility of redox polymer electrodialysis in treating a wide range of salinity levels and its potential for cascade operation, making it a promising technique for producing potable water from various concentrations of source water.

### Techno-Economic Analysis of Redox Polymer Electrodialysis System with Size-Exclusion Membranes

Techno-economic analysis (TEA) of the redox polymer electrodialysis system was evaluated to provide insights into economic feasibility and compared with conventional electrodialysis system with ion-exchange membranes and conventional desalination technologies. FIG. 22 shows TEA of redox-polymer electrodialysis (data circle) in comparison to the conventional desalination technologies (data diamond), where the water price for distillation (vapor compression distillation), brackish water/seawater reverse osmosis (BWRO, SWRO), ED, capacitive deionizations (CDI), and membrane CDI (MCDI) were referred to the literature values with a comparable water production volume. Treating an equal volume of source water (100 m³ per day), the redox polymer electrodialysis system significantly reduced water production costs ($0.134 per m³ of producing water) compared with IEM electrodialysis ($1.02 m⁻³), mainly due to the use of the cost-effective nanofiltration membranes, which cost only 5-10% of the IEMs. Based on the TEA for P(FPMAm₃₃-co-METAC₆₇) synthesis, the cost for the redox copolymer ($151 system⁻¹) accounts for 2.1% of the total capital cost in redox polymer electrodialysis. Besides, costs for both membrane and redox copolymer are less than 2.5% of the membrane costs for IEM electrodialysis. Moreover, a significant reduction in operating cost was observed in redox polymer electrodialysis, largely due to the low cost of membrane replacement and redox copolymer replacement by virtue of polymer recycling. Above all, the redox polymer electrodialysis system significantly reduced the electricity cost by 53% compared with the IEM electrodialysis, allowing a possible water-energy nexus system with the integration of renewable energy sources such as solar panels. The preliminary TEA analysis highlights the cost-effectiveness of the redox polymer electrodialysis compared to conventional desalination technologies such as vapor compression distillation (water production cost range $2-2.6 m⁻³), reverse osmosis ($0.7-1.7 m⁻³), and capacitive deionization ($0.17-0.25 m⁻³) (FIG. 22).

As demonstrated above, the redox polymer electrodialysis system presents a novel approach for replacing expensive and sensitive ion exchange membranes with cost-effective size-exclusion membranes while effectively reducing energy consumption. The system also demonstrated a significant salt removal rate (up to 99 mmol NaCl m⁻²h⁻¹) and charge efficiency (>90%), along with the capability to resist fouling and remove organic contaminants. Moreover, long-term operation using recycled P(FPMAm-co-METAC) demonstrates the stability and reusability of the redox copolymer.

The subject-matter of the disclosure may also relate to the following aspects:
A first aspect relates to a system for redox polymer electrodialysis, the system including: a first electrode; a second electrode positioned in opposition to the first electrode; a pair of size-exclusion membranes positioned between the first and second electrodes; an ion exchange membrane positioned between the pair of size-exclusion membranes, the ion exchange membrane defining a feed channel and an accumulating channel between the size-exclusion membranes; and a redox channel containing the first and second electrodes and being separated from the feed and/or accumulating channels by the pair of size-exclusion membranes.
A second aspect relates to the system of the first aspect, wherein the feed channel is configured for flow of water to be treated, wherein the accumulating channel is configured for collection of ionic species removed from the water, and wherein the redox channel is configured for flow of a redox solution.
A third aspect relates to the system of the first or second aspect, wherein the redox channel forms a closed loop.
A fourth aspect relates to the system of any preceding aspect, wherein the size-exclusion membranes have a molecular weight cut-off of 100,000 Da or less, 10,000 Da or less, 5,000 Da or less, 2,500 Da or less, or 1,000 Da or less.
A fifth aspect relates to the system of any preceding aspect, wherein the size-exclusion membranes have a nominal pore size of: at least about 0.1 nm, or at least about 0.2 nm, and/or up to about 10 nm, up to about 6 nm, or up to about 2 nm.
A sixth aspect relates to the system of any preceding aspect, wherein the size-exclusion membranes comprise nanofiltration membranes.
A seventh aspect relates to the system of any preceding aspect, wherein the size-exclusion membranes are configured to effect separation of ionic species based on size, and wherein the separation is independent of charge.
An eighth aspect relates to the system of any preceding aspect, wherein the size-exclusion membranes comprise cellulose.
A ninth aspect relates to the system of any preceding aspect, wherein the ion exchange membrane is a cation exchange membrane.
A tenth aspect relates to the system of the ninth aspect, wherein wherein the cation exchange membrane comprises a polymer film including negatively-charged functional groups
An eleventh aspect relates to the system of any of the first through the eighth aspects, wherein the ion exchange membrane is an anion exchange membrane.
A twelfth aspect relates to the system of the eleventh aspect, wherein the anion exchange membrane comprises a polymer film including positively-charged functional groups.
A thirteenth aspect relates to the system of the any preceding aspect, including up to n of the pairs of size-exclusion membranes, and including up to n+1 of the ion exchange membranes, wherein n is an integer, wherein the ion exchange membranes are positioned alternately with the size-exclusion membranes between the first and second electrodes.
A fourteenth aspect relates to the system of the thirteenth aspect, wherein the ion exchange membranes include only cation exchange membranes or only anion exchange membranes.
A fifteenth aspect relates to the system of any preceding aspect, comprising a stack of two or more of the first electrodes and a stack of two or more of the second electrodes.
A sixteenth aspect relates to the system of any preceding aspect, wherein the first and second electrodes comprise carbon.
A seventeenth aspect relates to the system of any preceding aspect, further comprising a power supply connected to the first and second electrodes.
An eighteenth aspect relates to the system of any preceding aspect, further comprising one or more pumps connected to the feed, redox, and/or accumulating channels.
A nineteenth aspect relates to a method for redox polymer electrodialysis, the method comprising: providing a system including: a first electrode; a second electrode positioned in opposition to the first electrode; a pair of size-exclusion membranes positioned between the first and second electrodes; an ion exchange membrane positioned between the pair of size-exclusion membranes, the ion exchange membrane defining a feed channel and an accumulating channel between the size-exclusion membranes; and a redox channel containing the first and second electrodes and being separated from the feed and/or accumulating channels by the pair of size-exclusion membranes; flowing a redox solution comprising a redox copolymer through the redox channel; flowing water to be treated through the feed channel, the water including salt and/or charged organic matter comprising ionic species; applying a voltage, the first electrode becoming positively charged and the second electrode becoming negatively charged, the redox copolymer undergoing oxidation near the first electrode and reduction near the second electrode, whereby the ionic species are drawn through the ion exchange membrane and the size-exclusion membrane adjacent to the feed channel, while the water remains in the feed channel, thereby achieving desalination and/or purification of the water.
A twentieth aspect relates to the method of the nineteenth aspect, wherein the water comprises industrial wastewater, municipal wastewater, seawater, and/or brine.
A twenty-first aspect relates to the method of the nineteenth or twentieth aspect, wherein the charged organic matter includes carboxylate(s), organic acid(s), fatty acid(s), per- and polyfluoroalkyl substances (PFAS), and/or surfactant(s).
A twenty-second aspect relates to the method of any of the nineteenth through the twenty-first aspects, wherein achieving desalination and/or purification of the water comprises removing at least about 95%, or at least about 99%, of the salt and/or the charged organic matter from the water.
A twenty-third aspect relates to the method of any of the nineteenth through the twenty-second aspects, wherein achieving desalination and/or purification comprises an energy consumption of about 90 kJ/mol or less, or about 80 kJ/mol or less.
A twenty-fourth aspect relates to the method of any of the nineteenth through the twenty-third aspects, further comprising maintaining the redox solution at a temperature above 25° C. and less than 100° C.
A twenty-fifth aspect relates to the method of any of the twenty-fourth aspect, wherein the temperature is greater than 30° C., greater than 50° C., or greater than 70° C.
A twenty-sixth aspect relates to the method of any of the nineteenth through the twenty-fifth aspects, wherein the voltage is in a range from 0.4 V to 1.2 V.
A twenty-seventh aspect relates to the method of any of the nineteenth through the twenty-sixth aspects, wherein the redox copolymer comprises a redox-active monomer and a water-soluble monomer.
A twenty-eighth aspect relates to the method of any of the nineteenth through the twenty-seventh aspects, wherein the redox copolymer includes a redox moiety comprising: nitroxide radicals or 2,2-diphenyl-1-picrylhydrazyl radicals, Wurster salts, quinones, compounds containing galvinoxyl radicals, phenoxyl radicals, triarylmethyl radicals, polychlorotriphenylmethyl radicals, phenalenyl radicals, cyclopentadienyl radicals, iminoxyl radicals, verdazyl radicals, nitronyl nitroxide radicals or thiazyl radicals, indigo, disulfides, thiafulvalenes, thioethers, thiolanes, thiophenes, viologens, tetraketopiperazine, quinoxaline, triarylamine, calix [4] arene, anthraquinonyl sulfide, phthalazine, cinnoline, ferrocene, carbazole, polyindole, polypyrrole, polyaniline, polythiophene, poly-N,N′-diallyl-2,3,5,6-tetraketopiperazine, 2,5-di-tert-butyl-4-methoxy phenoxy-propyl ester, poly-2-phenyl-1,3-dithiolane, poly [methanetetriletetrathio-methylene], poly-2,4-dithio-pentanylene, polyethene-1,1,2,2-tetrathiol, poly-3,4-ethylene dioxythiophene, 5,5-bismethylthio-2,2-bithiophene, poly-1,2,4,5-tetrakispropylthiobenzene, poly-5-amino-1,4-dihydrobenzo [d]-1′,2′ dithiadiene-co-aniline, poly-5,8-dihydro-1H, 4H-2,3,6,7-tetrathia-anthracene, polyanthra [1′,9′,8′-b,c,d,e] [4M 0′,5′-b′,c′,d′,e′] bis-[1,6,6a6a-SIV-trithia]-pentalene, polyenoligosulfide, poly-1,2-bisthiophen-3-ylmethyldisulfane, Poly-3-thienyl-methyl disulfide-co-benzyl disulfide, polytetrathionaphthalene, polynaphtho [1,8-cd] [1,2]-dithiol, poly-2,5-dimercapto-1,3,4-thiadiazole, polysulfide, polythiocyanogen, polyazulene, polyfluorene, polynaphthalene, polyanthracene, polyfuran, tetrathiafulvalene, polyoxyphenazine, and/or their isomers and derivatives, and/or wherein the redox moiety is connected to a polymer backbone derived from: ethylenically unsaturated carboxylic acids or their esters or amides, such as polymethacrylates, polyacrylates or polyacrylamides, polymers derived from ethylenically unsaturated aryl compounds, such as polystyrene, polymers derived from vinyl esters of saturated carboxylic acids or derivatives thereof, such as polyvinyl acetate or polyvinyl alcohol, derived from olefins or bi- or polycyclic olefins derived polymers such as polyethylene, polypropylene or polynorbornene, derived from imide-forming tetracarboxylic acids and diamines derived polyimides of naturally occurring polymers and their chemically modified derivatives, polymers such as cellulose or cellulose ethers, and polyurethanes, polyvinyl ethers, polythiophenes, polyacetylene, polyalkylene glycols, poly-7-oxanorbornene, polysiloxanes, and/or polyalkylene glycol and their derivatives, such as their ethers, preferably polyethylene glycol and derivatives thereof.
A twenty-ninth aspect relates to the method of the twenty-seventh or twenty-eighth aspect, wherein the redox-active monomer is selected from the group consisting of: ferrocenyl-propyl-methacrylamide (FPMAm), vinyl ferrocene (VFc), ferrocenylmethyl methacrylate (FMMA), ferrocenylethyl methacrylate (FEMA), 2-(methacryloyloxy)ethyl ferrocenecarboxylate (FcMA),TEMPO methacrylate, and N-4-vinylbenzyl-N′-methyl-4,4′-bipyridinium dichloride.
A thirtieth aspect relates to the method of any of the twenty-seventh through the twenty-ninth aspects, wherein the water-soluble monomer is selected from the group consisting of: [2-(methacryloyloxy) ethyl] trimethyl-ammonium chloride (METAC), poly(ethylene glycol) methacrylate (PEGMA), styrene sulfonic acid sodium salt, 3-Sulfopropyl methacrylate potassium salt, 2-Methacryloyloxyethyl phosphorylcholine (MPC), and 2-(N-3-Sulfopropyl-N,N-dimethyl ammonium)ethyl methacrylate (SBMA).
A thirty-first aspect relates to the method of any of the nineteenth through the thirtieth aspects, wherein the redox copolymer comprises a copolymer of ferrocenyl-propyl-methacrylamide and [2-(methacryloyloxy) ethyl] trimethyl-ammonium chloride (P(FPMAm-co-METAC)).
A thirty-second aspect relates to the method of any of the twenty-seventh through the thirty-first aspects, wherein a concentration of the redox-active monomer in the redox solution is in a range from greater than 0 mM to 2 M.
A thirty-third aspect relates to the method of the thirty-second aspect, wherein the concentration is less than 1 M, or less than 50 mM.
A thirty-fourth aspect relates to the method of any of the twenty-seventh through thirty-third aspects, wherein a ratio of the redox-active monomer to the water-soluble monomer is in a range from 1:1 to 1:3, from 1:1.5 to 1:2.5, or 1:2.
A thirty-fifth aspect relates to the method of any of the nineteenth through the thirty-fourth aspects, wherein the size-exclusion membranes are permeable to the ionic species but impermeable to the redox copolymer.
A thirty-sixth aspect relates to the method of any of the nineteenth through the thirty-fifth aspects, wherein the redox copolymer has a molecular weight above 1,000 g/mol, above 2,500 g/mol, or above 5,000 g/mol, and/or wherein the redox copolymer has a molecular weight of less than 100,000 g/mol, less than 70,000 g/mol, or less than 40,000 g/mol.
A thirty-seventh aspect relates to the method of any of the nineteenth through the thirty-sixth aspects, wherein the redox copolymer remains in the redox channel.
A thirty-eighth aspect relates to the method of any of the nineteenth through the thirty-seventh aspects, wherein the redox copolymer circulates through the redox channel during the application of the voltage, the oxidation near the first electrode and the reduction near the second electrode occurring repetitively.
A thirty-nineth aspect relates to the method of any of the nineteenth through the thirty-eighth aspects, wherein the redox channel contains no added electrolyte.
A fortieth aspect relates to the method of any of the nineteenth through the thirty-ninth aspects, wherein the size-exclusion membranes have a molecular weight cut-off of 100,000 Da or less, 10,000 Da or less, 5,000 Da or less, 2,500 Da or less, or 1,000 Da or less.
A forty-first aspect relates to the method of any of the nineteenth through the fortieth aspects, wherein the size-exclusion membranes have a nominal pore size of: at least about 0.1 nm, or at least about 0.2 nm, and/or up to about 2 nm, up to about 6 nm, or up to about 10 nm.
A forty-second aspect relates to the method of any of the nineteenth through the forty-first aspects, wherein the ionic species drawn through the ion exchange and size-exclusion membranes directly or indirectly enter the accumulating channel, wherein indirectly entering the accumulating channel entails passing first through the redox channel.
A forty-third aspect relates to the method of any of the nineteenth through the forty-second aspects, wherein the ionic species include: cationic species comprising cations and/or cationic organic species; and anionic species including anions and/or anionic organic species.
A forty-fourth aspect relates to the method of the forty-third aspect, wherein the ion exchange membrane is a cation exchange membrane, wherein the cationic species are drawn through the cation exchange membrane and into the accumulating channel, and wherein the anionic species are drawn through the size-exclusion membrane adjacent to the feed channel and into the redox channel prior to entering the accumulating channel.
A forty-fifth aspect relates to the method of the forty-third aspect, wherein the ion exchange membrane is an anion exchange membrane, wherein the anionic species are drawn through the anion exchange membrane and into the accumulating channel, and wherein the cationic species are drawn through the size-exclusion membrane adjacent to the feed channel and into the redox channel prior to entering the accumulating channel.
A forty-sixth aspect relates to the method of any of the forty-third through the forty-fifth aspects, wherein the anions and cations comprise Li⁺, Na⁺, K⁺, Mg²⁺, Ca²⁺, Cl⁻, NO₃⁻ and/or SO₄²⁻.
A forty-seventh aspect relates to the method of any of the forty-third through the forty-sixth aspects, wherein the cationic or anionic organic species comprise carboxylate(s), organic acid(s), fatty acid(s), per- and polyfluoroalkyl substances (PFAS), and/or surfactant(s).
A forty-eighth aspect relates to the method of any of the nineteenth through the forty-seventh aspects, wherein the system comprises: up to n of the pairs of size-exclusion membranes, and up to n+1 of the ion exchange membranes, wherein n is an integer, wherein the ion exchange membranes are positioned alternately with the size-exclusion membranes between the first and second electrodes.
A forty-ninth aspect relates to the method of the forty-eighth aspect, wherein the ion exchange membranes include only cation exchange membranes or only anion exchange membranes.
A fiftieth aspect relates to the method of any of the nineteenth through the forty-ninth aspects, wherein the system comprises a stack of two or more of the first electrodes and a stack of two or more of the second electrodes.
A fifty-first aspect relates to the method of any of the nineteenth through the forty-seventh aspects, comprising the system according to any one of the first through the eighteenth aspects.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A method for redox polymer electrodialysis, the method comprising:
providing a system including:
a first electrode;
a second electrode positioned in opposition to the first electrode;
a pair of size-exclusion membranes positioned between the first and second electrodes;
an ion exchange membrane positioned between the pair of size-exclusion membranes, the ion exchange membrane defining a feed channel and an accumulating channel between the size-exclusion membranes; and
a redox channel containing the first and second electrodes and being separated from the feed and/or accumulating channels by the pair of size-exclusion membranes;
flowing a redox solution comprising a redox copolymer through the redox channel;
flowing water to be treated through the feed channel, the water including salt and/or charged organic matter comprising ionic species;
applying a voltage, the first electrode becoming positively charged and the second electrode becoming negatively charged, the redox copolymer undergoing oxidation near the first electrode and reduction near the second electrode,
whereby the ionic species are drawn through the ion exchange membrane and the size-exclusion membrane adjacent to the feed channel, while the water remains in the feed channel,
thereby achieving desalination and/or purification of the water.

2. The method of claim 1, wherein the charged organic matter includes a carboxylate, an organic acid, a fatty acid, a per- and polyfluoroalkyl substance (PFAS), and/or a surfactant.

3. The method of claim 1, further comprising maintaining the redox solution at a temperature above 25° C. and less than 100° C.

4. The method of claim 1, wherein the voltage is in a range from 0.4 V to 1.2 V.

5. The method of claim 1, wherein the redox copolymer comprises a redox-active monomer and a water-soluble monomer.

6. The method of claim 5, wherein a ratio of the redox-active monomer to the water-soluble monomer is in a range from 1:1 to 1:3.

7. The method of claim 5, wherein a concentration of the redox-active monomer in the redox solution is in a range from greater than 0 mM to 2 M.

8. The method of claim 1, wherein the redox copolymer comprises a copolymer of ferrocenyl-propyl-methacrylamide and [2-(methacryloyloxy) ethyl] trimethyl-ammonium chloride (P(FPMAm-co-METAC)).

9. The method of claim 1, wherein the redox copolymer has a molecular weight in a range from about 1,000 g/mol to about 100,000 g/mol.

10. The method of claim 1, wherein the redox copolymer circulates through the redox channel during the application of the voltage, the oxidation near the first electrode and the reduction near the second electrode occurring repetitively.

11. The method of claim 1, wherein the size-exclusion membranes are permeable to the ionic species but impermeable to the redox copolymer.

12. The method of claim 1, wherein the size-exclusion membranes have a nominal pore size in a range from about 0.1 nm to about 10 nm.

13. The method of claim 1, wherein the ionic species include cationic species comprising cations and/or cationic organic species and anionic species comprising anions and/or anionic organic species,
wherein the ion exchange membrane is a cation exchange membrane,
wherein the cationic species are drawn through the cation exchange membrane and into the accumulating channel, and
wherein the anionic species are drawn through the size-exclusion membrane adjacent to the feed channel and into the redox channel prior to entering the accumulating channel.

14. A system for redox polymer electrodialysis, the system comprising:
a first electrode;
a second electrode positioned in opposition to the first electrode;
a pair of size-exclusion membranes positioned between the first and second electrodes;
an ion exchange membrane positioned between the pair of size-exclusion membranes, the ion exchange membrane defining a feed channel and an accumulating channel between the size-exclusion membranes; and
a redox channel containing the first and second electrodes and being separated from the feed and/or accumulating channels by the pair of size-exclusion membranes.

15. The system of claim 14,
wherein the feed channel is configured for flow of water to be treated,
wherein the accumulating channel is configured for collection of ionic species removed from the water,
wherein the redox channel is configured for flow of a redox solution,
wherein the size-exclusion membranes are configured to effect separation of ionic species based on size, and
wherein the separation is independent of charge.

16. The system of claim 14, wherein the size-exclusion membranes have a nominal pore size from about 0.1 nm to about 10 nm.

17. The system of claim 14, wherein the size-exclusion membranes comprise cellulose.

18. The system of claim 14, including up to n of the pairs of size-exclusion membranes, and
including up to n+1 of the ion exchange membranes, wherein n is an integer,
wherein the ion exchange membranes are positioned alternately with the size-exclusion membranes between the first and second electrodes.

19. The system of claim 18, wherein the ion exchange membranes include only cation exchange membranes or only anion exchange membranes.

20. The system of claim 14 comprising a stack of two or more of the first electrodes and a stack of two or more of the second electrodes.
